(19) United States
(12) Patent Application Publication
(10) Pub. No.: US 2013/0267289 A1
(43) Pub. Date: Oct. 10, 2013

(54) METHOD FOR PLAYING A CARD GAME COMBINING ELEMENTS OF BLACKJACK AND STUD POKER

(71) Applicants: Edward S. Kokosky, Henderson, NV (US); Terry R. Suominen, Henderson, NV (US)

(72) Inventors: Edward S. Kokosky, Henderson, NV (US); Terry R. Suominen, Henderson, NV (US)

(21) Appl. No.: 13/726,456

(22) Filed: Dec. 24, 2012

Related U.S. Application Data
(60) Provisional application No. 61/579,996, filed on Dec. 23, 2011.
(60) Provisional application No. 61/667,274, filed on Jul. 2, 2012.

(51) Int. Cl. G07F 17/32; A63F 1/00

(52) U.S. Cl. CPC G07F 17/3293; A63F 1/00
USPC 463/12; 273/292

(57) ABSTRACT

A card game combines the action of blackjack with the action of five-card stud. The participating players place a first wager and a second wager and an optional bonus wager. The participating players and the dealer are each dealt five cards. The players and dealer make a blackjack hand from their respective five cards. In order to win the first wager, the player's blackjack hand must beat the dealer's blackjack hand. The players and dealer then make a five-card stud hand from their respective five cards. In order to win the second wager, the player's five-card stud hand must beat the dealer's corresponding five-card stud hand. Additionally, players may place an optional bonus wager that is related to the poker ranking of the five cards received by the player. A pre-established pay table defines the bonus wager winning combinations and corresponding payouts.

### FIELD OF THE INVENTION

The present invention relates to a casino style card game. More particularly, wagering games played on casino-operated tables and via electronic game terminals combining elements of the traditional games of blackjack and stud poker.

### BACKGROUND

The game of blackjack is well established in gaming circles and has been a staple of the gambling world for a number of years. In the casino environment, the objective of blackjack or “21” is simple: to get cards totaling 21, or as close to 21 as possible without going over, and to get a better total than the dealer). The cards 2 through 10 count towards the blackjack hand total at their face value. Face cards—jack, queen, and king—count as ten, and aces can be counted as one or eleven. Suits do not matter in blackjack. Also, the rules of play for the dealer are strictly dictated, leaving no decisions up to the dealer. For example, the dealer must draw until the dealer's blackjack hand reaches at least a value of 17. So, the player is trying to achieve the highest value of his or her blackjack hand without “busting,” i.e. exceeding 21. As a player, to maximize profits, the objective is to score a blackjack, or a total of 21. This typically results in a 1.5 times payout of the player's original wager.

Five-card stud used to be the most popular poker game around. Westerns always featured five-card stud being played before the bad guy gets shot. The object of the game of five card stud is to make the best five card hand using the players own personal five cards. Just like almost every other form of poker, the best 5-card poker hand at showdown wins the wager, against, for example, several other players or against a dealer. The most desirable five-card hand would be the royal “flush” which would contain the highest ranking cards, the Ace, King, Queen, Jack, Ten, all having the same suit combination (e.g. all hearts). Continuing, the least desirable hand would be a random mixture of five of the lowest ranking cards, namely a Two, Three, Four, Five, Six, Seven, all of differing suits. Hence, it can be seen that poker ranks cards according to the value of the individual card as well as by the combinations which the cards make when combined together.

### SUMMARY

In one embodiment, a method of playing a card game or wagering game utilizing one or more decks of standard playing cards is disclosed. In general, each player plays his blackjack hand against the dealer's with a pre-determined rule that the hand closest to twenty-one without going over twenty-one wins the first segment of the game, and each player plays his five-card stud hand against the dealer's five-card stud hand with a pre-determined rule that the hand with the highest valued five-card stud poker hand wins the second segment of the game. More specifically, the wagering game of the illustrated embodiment begins by accepting a first wager and a second wager from each participating player. Each player is then dealt five cards—two cards are dealt face-up and three cards are dealt face-down. The two face-up cards constitute a player's blackjack hand, and the remaining three face-down cards are used to complete the player's blackjack hand if needed. The dealer is also dealt five cards—one card is dealt face-up and four cards are dealt face-down. The one face-up card constitutes a dealer's blackjack hand, and the remaining four face-down cards are used to complete the dealer's blackjack hand.

Each participating player makes each player's blackjack hand and the dealer makes the dealer's blackjack hand by using their respective five cards. If, in making the player's blackjack hand, the player's blackjack exceeds twenty-one, the casino or house would collect the first wager. If the player's blackjack hand does not exceed twenty-one, the wagering game continues by comparing the rank of the dealer's blackjack hand to the rank of each remaining player's blackjack hand. The house or casino then settles each player's first wager dependent upon the comparison of the rank of the dealer's blackjack hand to the rank of each player's blackjack hand.

The wagering game of the described embodiment continues by exposing each player's five cards to make each player's five-card stud hand and exposing the dealer's five cards to make the dealer's five-card stud hand. The rank of the dealer's five-card stud hand is then compared to the rank of each player's five-card stud hand. The house or casino then settles each player's second wager dependent upon the comparison of the rank of the dealer's five-card stud hand to the rank of each player's five-card stud hand.

In another embodiment, the method and apparatus includes players and the dealer each receiving 5 cards. Within the overall scope of the invention, every player's 5 card hand can be constituted from individual five cards or a combination of community cards and individual cards. It should be apparent to one of ordinary skill in the art that the chosen number of cards for each hand does not impact the art of the invention. Furthermore, in this description, “card” is used to represent standard poker cards, tiles, digital representation thereof, or any apparatus with similar characteristics.

In another embodiment, each player plays his player hand against the dealer hand with a pre-determined rule that the hand with highest number of cards forming a straight wins and that when two hands with equal number of cards forming a straight, the one with the higher poker card wins. In yet another embodiment, each player plays his player hand against the dealer hand with a pre-determined rule that the hand with the highest number of picture cards win and that when two hands of equal number of picture cards, the one with the higher poker card wins. Alternatively, each player plays his player hand against the dealer hand with a pre-determined rule that the hand with highest number of non-picture cards (i.e. Ten or lower) wins and that when two hands with equal number of non-picture cards, the one with higher poker card wins.

It is apparent that the embodiments herein described are variations of the present invention. In the following brief description, the terms “21 Stud” or “Twisted 21” are used to elaborate the arts of the invention. The rankings are defined as follows in the five-card stud hand: (a) royal flush outranks straight flush; (b) straight flush outranks four of a kind; (c) four of a kind outranks a full house; (d) full house outranks a flush: (e) flush outranks a straight; (f) straight outranks a three of a kind; (g) three of a kind outranks two pair; (h) two pair outrank a pair; and (i) a pair outranks high hand no pair. So, wins and losses depend upon where the player's or dealer's five card stud hand falls on the spectrum. For example, a hand described in (f) beats the hands described in (g)-(i), however, loses to the hands described in (a)-(e). Accordingly, any comparison of a player's five card stud hand to the dealer's five-card stud hand would typically follow the above listed hierarchy. One of ordinary skill in the art can appreciate that hand rankings (a)-(i) may be ordered differently if so desired.

### BRIEF DESCRIPTION OF THE FIGURES

The invention will be more fully understood by reference to the following drawings which are for illustrative purposes only:

FIG. 1 shows a table layout designed to facilitate implementation of the embodiments of the present invention;

FIG. 2 shows an enlarged view of one embodiment of a player position shown in FIG. 1;

FIG. 3 illustrates one embodiment of a sample payout table including pre-established winning combinations and corresponding payouts in accordance with the present invention;

FIG. 4 shows a table layout designed to facilitate implementation of the embodiments of the present invention;

FIG. 5 shows an enlarged view of one embodiment of a player position shown in FIG. 4;

FIG. 6 shows a flowchart detailing a first embodiment of the present invention;

FIG. 7 shows a flow chart for an optional bonus bet;

FIG. 8 shows a flowchart detailing another embodiment of the present invention that may be referred to generally as 21 Stud; and

FIG. 9 shows a flowchart detailing yet another embodiment of the present invention that may be referred to generally as Twisted 21.

### BRIEF DESCRIPTION

Embodiments of the present invention disclose a merging of the game of blackjack or “21” with the game of five-card stud, with a unique dealing process that makes the game fun with added protection for the house or casino. In one embodiment, the present invention includes using a 52 card deck of cards to play the game. One of ordinary skill in the art will appreciate that the game may be played with more decks of cards, and may also be played with or without jokers, which, if in play, are typically wild. The game can also be played where each player's hand is the result of combining certain community cards and individual cards.

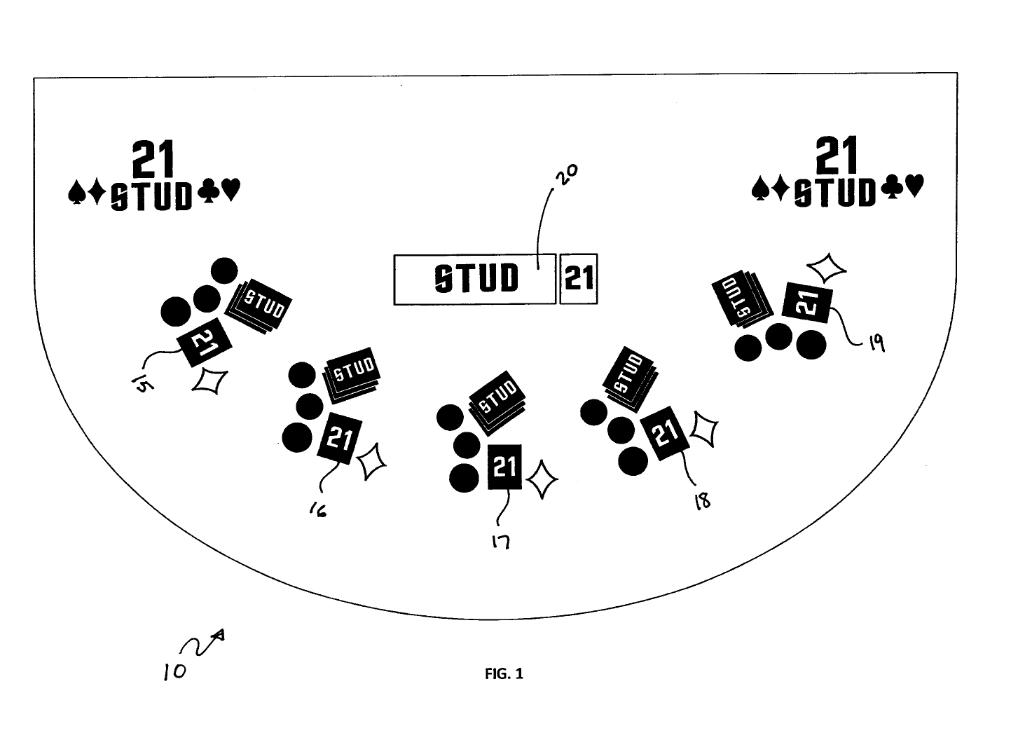

The present invention is described herein with reference to FIG. 1 through FIG. 9, which are presented for illustrative purposes. It will be appreciated that the present invention may vary as to the particular steps and their sequence without departing from the basic concepts as disclosed herein.

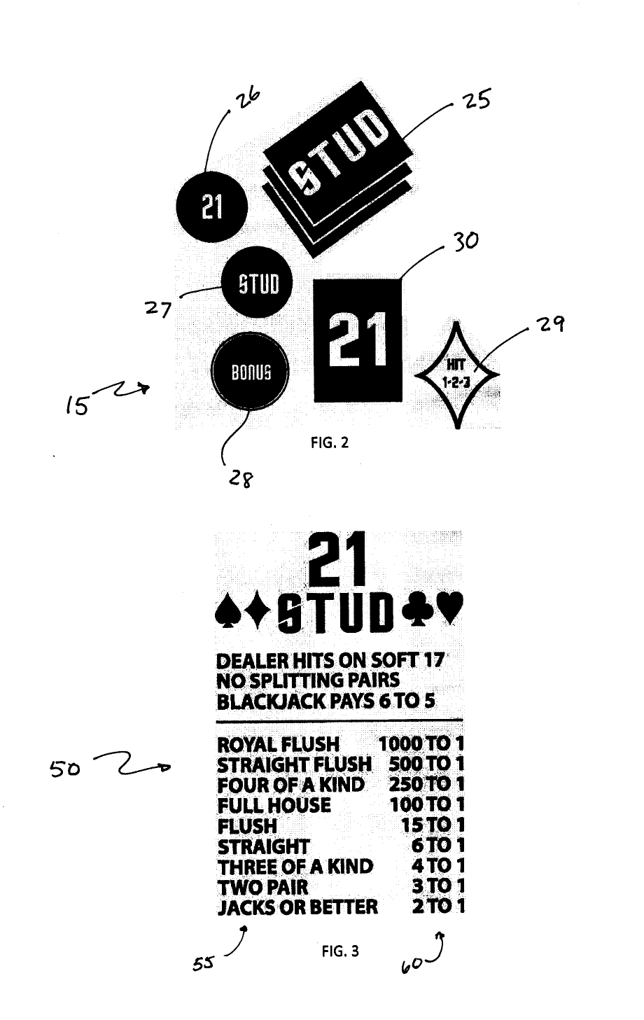

FIG. 1 illustrates a table layout generally denoted as reference numeral 10 for one embodiment of the invention, referred to herein as the game 21 Stud. The layout 10 includes five player positions 15 through 19 for receiving the cards required to make the player's blackjack hand and the player's five-card stud hand, each having, as shown more specifically in FIG. 2, a two-card hand placement position 30, a three-card face-down card placement position 25, a first wagering position 26, a second wagering position 27, an optional bonus wagering position 28 and a position for the player to point to indicate the desire to receive a “hit.” A dealer position 20 is adjacent a chip tray. Even though the layout 10 illustrates five player positions 15 through 19, the embodiments of the present invention can be played by any number of players simultaneously. While an amount of first, second and bonus wagers will be dictated by the casino, it is contemplated that an amount of second and bonus wagers will be in a minimum/maximum range in a pre-established amount (e.g. $1-$25).

In traditional blackjack and in at least a first embodiment of the present invention, the player in the first position 15 is selected to be the recipient of the first grouping of five cards from the shuffled deck, two cards face-up in position 30 and three cards stacked face-down in position 25. The remaining players receive their respective five card groupings in a counterclockwise fashion starting from the selected player.

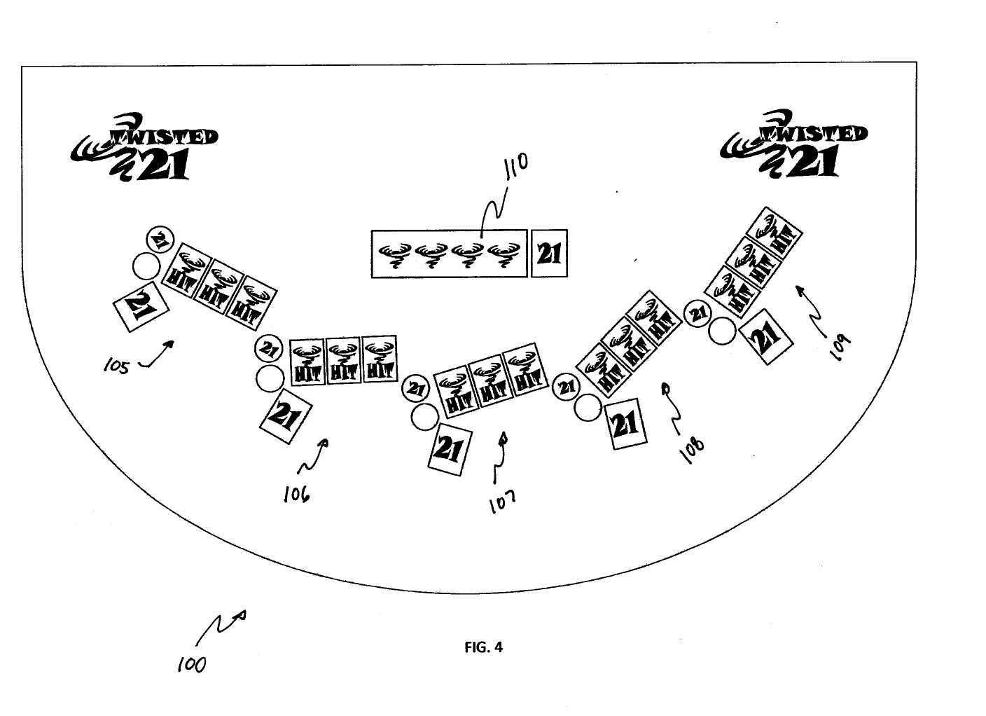

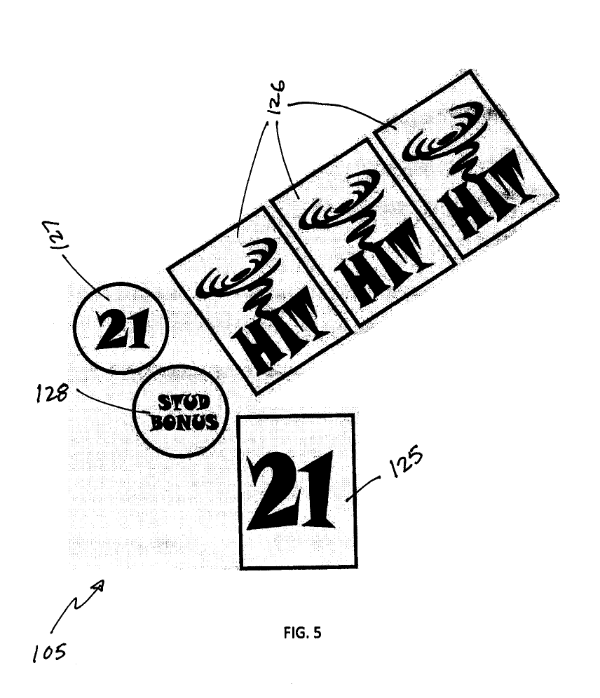

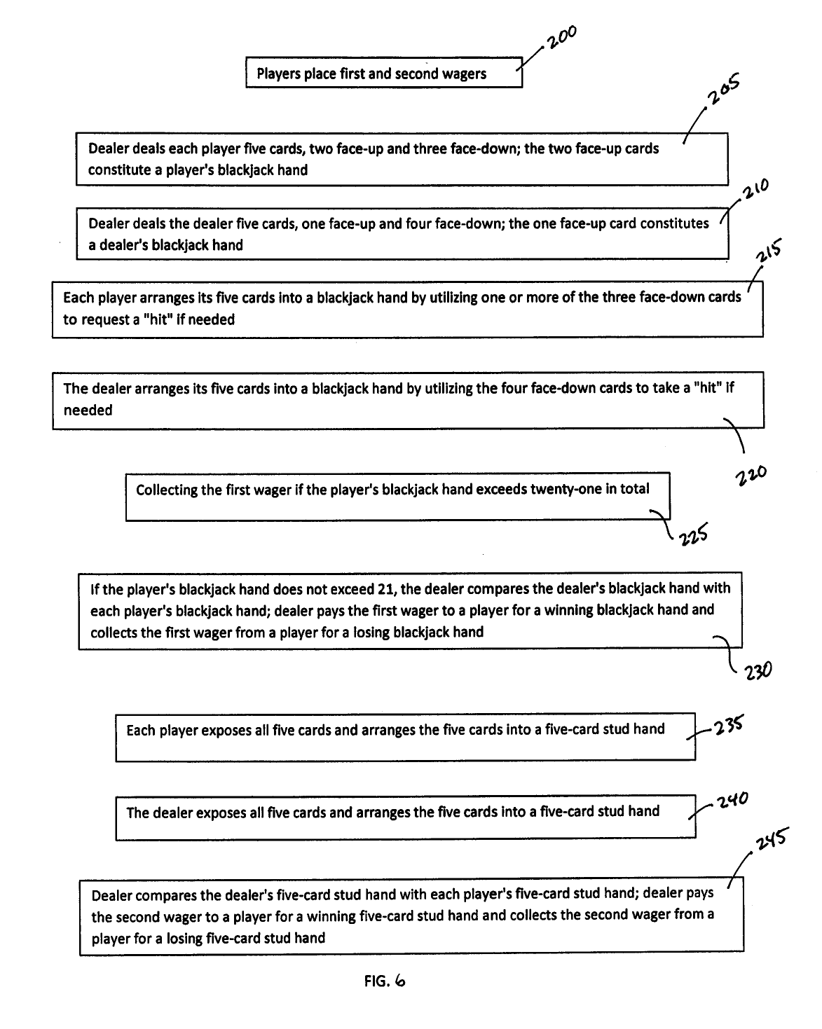

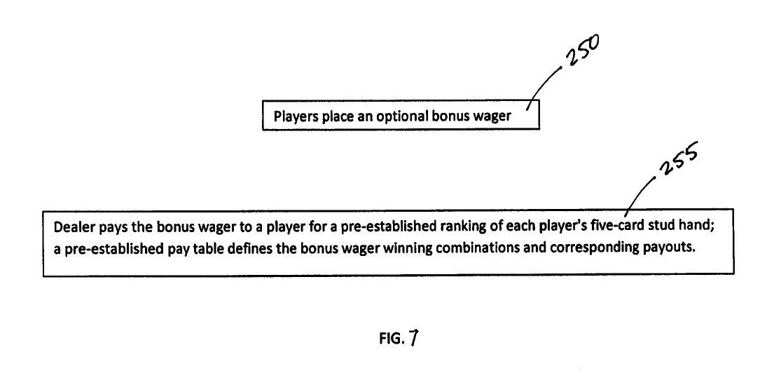

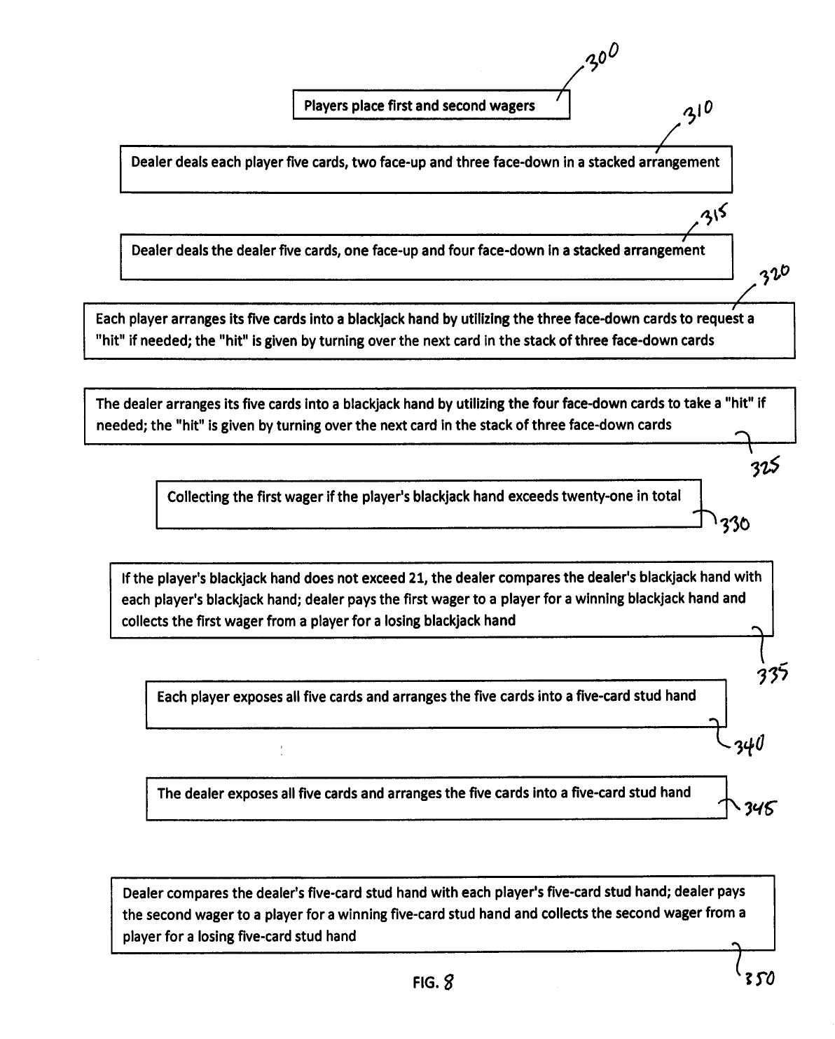

FIG. 3 illustrates a first proposed pay table 50 defining winning five-card combinations 55 and corresponding payouts 60 for the optional bonus wager. The payouts 60 set forth in the pay table 50 corresponds to a multiple of the optional bonus wager.

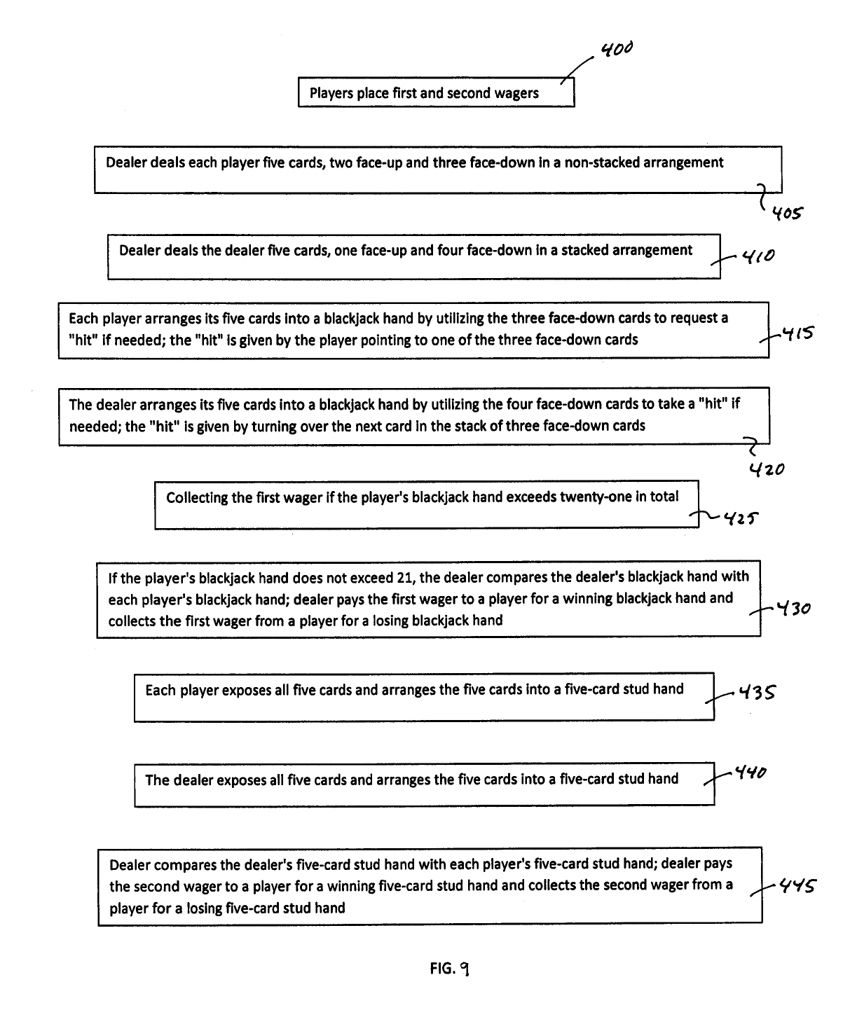

FIG. 4 illustrates a table layout generally denoted as reference numeral 100 for another embodiment of the invention, referred to herein as the game Twisted 21. The layout 100 includes five player positions 105 through 109 for receiving the cards required to make the player's blackjack hand and the player's five-card stud hand, each having, as shown more specifically in FIG. 5, a two-card hand placement position 125, a three-card face-down card placement position 126, a first wagering position 127 and a second wagering position 128. A dealer position 110 is typically adjacent a chip tray. Even though the layout 100 illustrates five player positions 105 through 109, the embodiments of the present invention can be played by any number of players simultaneously. While an amount of first, second and bonus wagers will be dictated by the casino, it is contemplated that an amount of second and bonus wagers will be in a minimum/maximum range in a pre-established amount (e.g. $1-$25).

FIG. 6 shows a flow chart detailing a first embodiment of the present invention. At step 200, players place their first and second wagers. In the illustrated embodiment, the first wager is associated with the game of blackjack and the second wager is associated with the game of five-card stud. The minimums and maximums of the first and second wagers are typically pre-established by a casino conducting the embodiments of the present invention. For example, a casino may establish wagering limits between $25 and $2000 for the first wager. Although an amount of the second wager is also pre-established by the casino, it is contemplated that the second wager could be a lesser amount, in a range such as $5-$200 per hand. In one embodiment, the first wager is mandatory and the second wager is optional. In another embodiment, the first and second wagers are both mandatory.

At step 205, each player receives their five cards in a counter clockwise fashion starting with the player in the furthest right player position, as viewed from the perspective of the dealer. The five cards are dealt as follows: two cards face-up and three cards face-down, where the two exposed cards represent the starting value of the player's blackjack hand. In one embodiment, every player position is dealt, even if the position is vacant. At step 210, the dealer (e.g., the house) receives its five cards. The five cards are dealt as follows: one card face-up and four cards face-down, where the single exposed card represents the starting value of the dealer's blackjack hand. At step 215, each player makes its respective player blackjack hand by utilizing one or more of the three facedown cards to request a “hit” to be added to the value of the two initially exposed cards. The player blackjack hand wins if the first two cards are an ace and a face card, as long as the dealer doesn't have the same hand, which typically means a loss of the player hand. If the player requests a “hit” from the face-down cards and the total of the player's blackjack hand exceeds twenty-one, the player “busts” or loses, and the house or casino collects the player's first wager. In one embodiment, if the player turns over all five of the cards and the total is less than seventeen, the player automatically wins the first wager. One of ordinary skill in the art will appreciate that the total associated with the five card automatic win (e.g., seventeen as shown) may be greater or less than seventeen depending upon the desired house advantage.

Once all players have made their respective blackjack hands, at step 220, the dealer makes his or her dealer blackjack hand by exposing one or more of the four face-down cards pursuant to a casino's pre-established rules. For example, a casino's pre-established rule might require the dealer to take a hit on a soft 17 (i.e., an ace paired with a six). At step 225, the dealer collects the first wager on behalf of the casino or house from any player whose blackjack hand exceeds twenty-one. If a player's hand does not exceed twenty-one, at step 230, the dealer compares that player's blackjack hand with the dealer's blackjack hand and pays on the first wager if the player's blackjack hand is a winning blackjack hand (i.e., the player's blackjack hand is greater than the dealer's blackjack hand, without busting—i.e., going over twenty-one) or collects the first wager if the player's blackjack hand is a losing blackjack hand. The comparison of step 230 is repeated for each player that did not exceed twenty-one in value when constructing his or her blackjack hand in step 205. If the dealer exceeds twenty-one, all player's that have a blackjack hand that did not bust automatically win.

At step 235, the dealer (or the individual players, if allowed to touch the cards) exposes all five cards of any player that placed a second wager in step 200 and arranges the five cards into each player's five-card stud hand. At step 240, the dealer exposes all five dealer cards and arranges the five cards into each dealer's five-card stud hand. At step 245, the dealer compares each participating player's five-card stud hand with the dealer's five-card stud hand and pays on the player's second wager if the player's hand is a winning five-card stud hand or collects the second wager if the player's five-card stud hand is a losing five-card stud hand. The five-card stud hands are typically settled according to hand rankings described in the summary section above. If the player's five-card stud hand and the dealer's five-card stud hand have similar ranking hands, then the highest card in the player's hand or the dealer's hand will determine the winning hand. The comparison of step 245 is repeated for each player that placed a second wager in step 200.

FIG. 7 illustrates an optional bonus bet. In the illustrated embodiment shown in the flow chart of FIG. 7, at step 250, the player places an optional bonus wager at the same time the first and second wagers are placed in step 200 described above. In one embodiment, the optional bonus wager cannot be placed without placing the second wager on the five-card stud hand. At the completion of the comparison in step 245, for example, the player's five-card stud hand is compared to a pay table, such as the pay table illustrated in FIG. 3. The pay table establishes the bonus wager winning combinations and corresponding payouts. One of ordinary skill in the art will appreciate that any pay table may be used without departing from the scope and spirit of the present invention. Continuing, at step 255, the dealer pays the optional bonus wager to a player for the ranking of the player's five-card stud hand according to the pre-established payouts in the pay table.

FIG. 8 shows a flow chart detailing an illustrated embodiment of the present invention, generally referred to herein as “21 Stud.” In the illustrated embodiment, the game of “21 Stud” typically has three wagering zones: (i) “21” spot is to wager only on the game of 21; (ii) “Stud” spot is to wager only on the game of five-card stud; and (iii) “Bonus” spot is to wager only on the outcome of the five-card stud hand against the pay table, see FIG. 3 for example. Minimum play is to wager on the “21” Zone. In one embodiment, to wager on the “Stud” Zone you must have a wager in the “21” Zone. In another embodiment, to wager in the “Bonus” Zone you must have wagers in the “21” and “Stud” Zones. “21” and “Stud” wager zones are typically of equal denomination. The “Bonus” Zone is typically a $1 to $5 dollar wager, but may be more if desired. Payouts on the wagering zones are typically as follows: (i) “21” wager or first wager is even money; (ii) “Stud” wager or second wager one is even money; and (iii) “Bonus” wager is as per approved pay out table in FIG. 3, for example.

At step 300, players place their first and second wagers. At step 310, each player receives their five cards. The five cards are dealt as follows: two cards face-up and three cards face- down in a stacked arrangement, where the two exposed cards represent the starting value of the player's blackjack hand. In one embodiment, every player position is dealt, even if the position is vacant. At step 315, the dealer (e.g., the house) is dealt its five cards. The five cards are dealt to the dealer as follows: one card face-up and four cards face-down in a stacked arrangement, where the single exposed card represents the starting value of the dealer's blackjack hand. At step 320, each player makes its respective player blackjack hand by utilizing one or more of the three facedown cards to request a “hit” to be added to the value of the two initially exposed cards. If the player requests a “hit” from the face-down cards, the next card in the stack is exposed and becomes part of the player's blackjack hand. If the player requests a hit and the total of the player's blackjack hand exceeds twenty-one, the player “busts” or loses, and, as shown in step 330, the house or casino collects the player's first wager. In one embodiment, if the player turns over all five of the cards and the total is less than seventeen, the player automatically wins the first wager. One of ordinary skill in the art will appreciate that the total associated with the five card automatic win (e.g., seventeen as shown) may be greater or less than seventeen depending upon the desired house advantage.

Once all players have made their respective blackjack hands, at step 325, the dealer makes his or her dealer blackjack hand by exposing one or more of the four face-down cards pursuant to a casino's pre-established rules. For example, a casino's pre-established rule might require the dealer to take a hit on a soft seventeen (i.e., an ace paired with a six). At step 330, the dealer collects the first wager on behalf of the casino or house from any player whose blackjack hand exceeds twenty-one. If a player's hand does not exceed twenty-one, at step 335, the dealer compares that player's blackjack hand with the dealer's blackjack hand and pays on the first wager if the player's blackjack hand is a winning blackjack hand or collects the first wager if the player's blackjack hand is a losing blackjack hand. The comparison of step 335 is repeated for each player that did not bust when constructing his or her blackjack hand in step 310. If the dealer exceeds twenty-one, all player's that have a blackjack hand that did not bust automatically win.

At step 340, the dealer (or the individual players, if allowed to touch the cards) exposes all five cards of any player that placed a second wager in step 300 and arranges the five cards into each player's five-card stud hand. At step 345, the dealer exposes all five dealer cards and arranges the five cards into the dealer's five-card stud hand. At step 350, the dealer compares each participating player's five-card stud hand with the dealer's five-card stud hand and pays on the player's second wager if the player's hand is a winning five-card stud hand or collects the second wager if the player's five-card stud hand is a losing five-card stud hand. The five-card stud hands are typically settled according to hand rankings described in the summary section above. If the player's five-card stud hand and the dealer's five-card stud hand have similar ranking hands, then the highest card in the player's hand or the dealer's hand will determine the winning hand. The comparison of step 350 is repeated for each player that placed a second wager in step 300. If the optional bonus wager illustrated and described with respect to FIG. 7 is placed, then step 255 shown in FIG. 7 is also performed.

FIG. 9 shows a flow chart detailing an illustrated embodiment of the present invention, generally referred to herein as “Twisted 21.” At step 400, players place their first and second wagers. At step 405, each player receives their five cards. The five cards are dealt as follows: two cards face-up and three cards face-down in a non-stacked arrangement, for example side-by-side as shown in FIG. 4. The two exposed cards represent the starting value of the player's blackjack hand. In one embodiment, every player position is dealt, even if the position is vacant. At step 410, the dealer (e.g., the house) is dealt its five cards. The five cards are dealt to the dealer as follows: one card face-up and four cards face-down in a stacked arrangement, where the single exposed card represents the starting value of the dealer's blackjack hand. At step 415, each player makes its respective player blackjack hand by utilizing one or more of the three facedown cards to request a “hit” to be added to the value of the two initially exposed cards. If the player requests a “hit” from the face-down cards, the player may optionally select which of the three face-down cards is exposed and, therefore, becomes part of the player's blackjack hand.

If the player requests a hit and the total of the player's blackjack hand exceeds twenty-one, the player “busts” or loses, and, as shown in step 425, the house or casino collects the player's first wager. In one embodiment, if the player turns over all five of the cards and the total is less than seventeen, the player automatically wins the first wager. One of ordinary skill in the art will appreciate that the total associated with the five card automatic win (e.g., seventeen as shown) may be greater or less than seventeen depending upon the desired house advantage.

Once all players have made their respective blackjack hands, at step 420, the dealer makes his or her dealer blackjack hand by exposing one or more of the four face-down cards pursuant to a casino's pre-established rules. For example, a casino's pre-established rule might require the dealer to take a hit on a soft seventeen (i.e., an ace paired with a six). In one embodiment, a player may select which of the four face-down cards are used in the dealer's blackjack hand. At step 425, the dealer collects the first wager on behalf of the casino or house from any player whose blackjack hand exceeds twenty-one. If a player's hand does not exceed twenty-one, at step 430, the dealer compares that player's blackjack hand with the dealer's blackjack hand and pays on the first wager if the player's blackjack hand is a winning blackjack hand or collects the first wager if the player's blackjack hand is a losing blackjack hand. The comparison of step 430 is repeated for each player that did not bust when constructing his or her blackjack hand in step 415. If the dealer exceeds twenty-one, all player's that have a blackjack hand that did not bust automatically win.

At step 435, the dealer (or the individual players, if allowed to touch the cards) exposes all five cards of any player that placed a second wager in step 400 and arranges the five cards into each player's five-card stud hand. At step 440, the dealer exposes all five dealer cards and arranges the five cards into the dealer's five-card stud hand. At step 445, the dealer compares each participating player's five-card stud hand with the dealer's five-card stud hand and pays on the player's second wager if the player's hand is a winning five-card stud hand or collects the second wager if the player's five-card stud hand is a losing five-card stud hand. The five-card stud hands are typically settled according to hand rankings described in the summary section above. If the player's five-card stud hand and the dealer's five-card stud hand have similar ranking hands, then the highest card in the player's hand or the dealer's hand will determine the winning hand. The comparison of step 445 is repeated for each player that placed a second wager in step 300. If the optional bonus wager illustrated and described with respect to FIG. 7 is placed, then step 255 shown in FIG. 7 is also performed.

As described above with respect to FIG. 7, the optional bonus wager is resolved after all other wagers are completed. Any of the bonus hands could be in either the player's or the dealer's five-card stud hand. All wagers are typically placed before the game starts. One optional payout table for the bonus wager is:

| | |
|---|---|
| Royal Flush | 250 to 1 |
| Straight Flush | 100 to 1 |
| Full House | 50 to 1 |
| Flush | 25 to 1 |
| Straight | 15 to 1 |
| Three of a Kind | 10 to 1 |
| Two Pair | Push |
| Pair or High Hand | Lose |

In another embodiment, the payout table for the optional bonus wager is:

| | |
|---|---|
| Royal Flush | 250 to 1 |
| Straight Flush | 100 to 1 |
| Full House | 50 to 1 |
| Flush | 20 to 1 |
| Straight | 15 to 1 |
| Three of a Kind | 10 to 1 |
| Two Pair | Push |
| Pair or High Hand | Lose |

In another embodiment, the payout table for the optional bonus wager is:

| | |
|---|---|
| Royal Flush | 250 to 1 |
| Straight Flush | 100 to 1 |
| Full House | 50 to 1 |
| Flush | 20 to 1 |
| Straight | 15 to 1 |
| Three of a Kind | 10 to 1 |
| Two Pair | Lose |
| Pair or High Hand | Lose |

In yet another embodiment, the payout table for the optional bonus wager is:

| | |
|---|---|
| Two Pair | 40 to 1 |
| High Hand with a face card | 30 to 1 |
| High Hand without a face card | 15 to 1 |
| One Pair | Push |
| Others | Lose |

The Royal bonus bet is another bet that is based on both the player and the dealer having a straight flush or a royal flush in both hands. A typical payout table is as follows:

| | |
|---|---|
| Straight flush in player and dealers hand | 1000 to 1 |
| Straight flush and royal flush in player and dealer hand | 2000 to 1 |
| Royal flush in player and dealers hand | 5000 to 1 |
| 5 card Straight flush with a combination of player and | 50 to 1 |
| dealers cards | |
| 5 card Royal flush with a combination of player and | 100 to 1 |
| dealers cards | |

The following sections illustrate and describe optional variations on the embodiments described above.

The “Lo Stud” Game

Upon completion of the blackjack portion of the wagering game, the players are given the option of touching their cards and turn up any facedown cards to play out the five-card stud portion of the game. All cards stay at their respective original locations where dealt.

The dealer also exposes all remaining facedown cards to form the best “five-card to stud” poker hand to compete against the player's best “five-card to stud” poker hand. The objective of the five-card to stud game is the player and the dealer formulate lowest possible five card poker hand, with the lowest possible poker hand being the winner. Poker hand rankings are as described the summary section above. Poker hand ranking with a non-pair lowest card being the lowest poker hand (i.e., best five-card lo stud hand) (e.g., 7, 5, 4, 3 and 2 of a mixed combination of suits) and a Royal Flush being the highest hand (i.e., worst five-card lo stud hand).

The “Hi/Lo Stud” Game as a Side Bet

The player can make a side wager prior to the cards being dealt to select the outcome of the player's poker hand verses the dealer's poker hand. The player with have the option to place a wager on an individually identified wagering zone specifically labeled “High Stud” or “Lo Stud” in addition to the specified “21”, “Stud” and “Bonus” zones as illustrated in FIG. 2.

The “Wild Card” Game

The game of “21 Stud” illustrated and described above can be played with one or two Jokers found in the standard poker deck of 54 playing cards. The jokers will change the hierarchy of the Poker Hand Ranking.

The “7 Card 21 Stud” Game

The present invention may be played with seven cards, cards six and seven are known as “Community Cards” that are placed face down in the designated locations on the table. Upon completion of the blackjack game, card six and card seven are turned face up. Cards six and seven are used as additional cards to formulate a five-card stud poker hand verses the dealer's five-card stud poker hand. All rules and payouts are in effect the same as in the five-card stud steps illustrated and described with respect to FIGS. 6-9 above.

The “7 Card 21 Lo Stud” Game

Upon completion of the blackjack game, the players may now touch their cards and turn up any facedown cards to play out the “Seven Card Stud” portion of the game. All cards stay at their respective original locations where dealt.

The dealer turns up card six and card seven, known as “Community Cards” as well as all remaining facedown cards to form the best “Five-Card Lo Stud” Poker hand to compete against the player's best “Five Card Lo Stud” Poker hand. The game's objective is the Player and the Dealer formulate lowest possible five card poker hand including the “Community Cards” and compete with the lowest possible poker hand being the winner. Poker Hand Rankings are as described in the summary section above, with a non-pair lowest card being the lowest poker hand (e.g., 7, 5, 4, 3 and 2 of a mixed combination of suits) and a Royal Flush being the highest hand. The game of “7 Card 21 Lo Stud” can be played with one or two Jokers found in the standard poker deck of 54 playing cards.

The embodiments of the present invention may be implemented live as a live table game or online. The embodiments of the present invention may also be implemented into an electronic medium, such as an electronic video machine. Those skilled in the art understand that computer processors may be programmed to display and deal simulated card hands on a video screen or the like. A player then uses selection means, including buttons or touch screen technology, to arrange his or her cards and the processor arranges the simulated dealer's cards in a preprogrammed fashion. The processor then determines whether the player has won, lost or pushed the primary wager and further determines whether any secondary wager has been won or lost. Thereafter, the processor causes the player to be credited any winning amounts and deducts any losing amounts.

The embodiments may also be facilitated by electronic gaming devices or a global computer network (e.g., Internet). In the electronic version, the hand(s) of the player(s) and dealer take the form of video representations of playing cards displayed on a screen, under the control of a microprocessor operating under a suitable program.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

While the invention has been particularly shown and described with reference to various embodiments thereof, it will be understood by those skilled in the art that various other changes in the form and details may be made without departing from the spirit and scope of the invention.

We claim:

1. A method of playing a wagering game utilizing one or more decks of standard playing cards comprising:
accepting a first wager and a second wager from each participating player;
dealing each player five cards, two cards are dealt face-up and three cards are dealt face-down, wherein the two face-up cards constitute a player's blackjack hand;
dealing a dealer five cards, one card is dealt face-up and four cards are dealt face-down, wherein the one face-up card constitutes a dealer's blackjack hand;
requiring each participating player to make each player's blackjack hand and the dealer to make the dealer's blackjack hand using their respective five cards;
collecting the first wager if the player's blackjack hand exceeds twenty-one in total;
if the player's blackjack hand does not exceed twenty-one, comparing the rank of the dealer's blackjack hand to the rank of each player's blackjack hand;
settling each player's first wager dependent upon the comparison of the rank of the dealer's blackjack hand to the rank of each player's blackjack hand;
exposing each player's five cards to make each player's five-card stud hand and exposing the dealer's five cards to make the dealer's five-card stud hand;
comparing the rank of the dealer's five-card stud hand to the rank of each player's five-card stud hand; and
settling each player's second wager dependent upon the comparison of the rank of the dealer's five-card stud hand to the rank of each player's five-card stud hand.

2. The method of playing a wagering game of claim 1, further comprising utilizing one of the three face-down cards in the player's blackjack hand if the player requests a hit, and utilizing one of the four face-down cards in the dealer's blackjack hand if the dealer is required to take a hit, wherein the dealer is required to take a hit when the dealer's blackjack hand is less than seventeen in total.

3. The method of playing a wagering game of claim 1, wherein said requiring each participating player to make a blackjack hand by using their five cards further comprises each player pointing to a face-down card the player would like exposed, and adding the value of the exposed card to the value of the cards previously exposed in the player's blackjack hand.

4. The method of playing a wagering game of claim 1, wherein a player automatically wins the blackjack hand if all five of the player's cards are exposed, and the value of the five cards in total is less than seventeen.

5. The method of playing a wagering game of claim 1, wherein said five card stud hand is a five-card lo stud hand.

6. The method of playing a wagering game of claim 1, further comprising accepting a bonus wager from a participating player, and having a payout associated with pre-established ranking of each player's five-card stud hand.

7. The method of playing a wagering game of claim 1, wherein the one or more decks include a joker which can be used as a wild card or to complete certain pre-established hands.

8. The method of playing a wagering game of claim 1, wherein the player's three face-down cards are stacked, and the player's blackjack hand is constructed by flipping over the next card in the stack to be utilized in the player's blackjack hand when the player requests a hit.

9. The method of playing a wagering game of claim 1, wherein the player's three face-down cards are separate and not stacked, and the blackjack hand is constructed by the player pointing to one of the player's three face-down cards to be exposed and to be utilized in the player's blackjack hand when the player requests a hit.

10. An electronically implemented method of playing a wagering game comprising:
providing a processing unit, display screen and selection means; accepting an inputted first and second wager from a player;
displaying five player cards, two cards face-up and three cards face-down, wherein the two face-up cards constitute a player's blackjack hand;
displaying five dealer cards, one card face-up and four cards face-down, wherein the one face-up card constitutes a dealer's blackjack hand;
the player using the selection means to select a face-down card to be utilized in the player's blackjack hand when a hit is desired;
if the player's blackjack hand does not exceed twenty-one, the player utilizing the selection means to indicate that the player desires to stand on the player's blackjack hand;
said processing unit arranging the dealer's five cards into a dealer's blackjack hand;
said processing unit comparing the rank of the dealer's blackjack hand to the rank of the player's blackjack hand;
said processing unit settling the player's first wager dependent upon the comparison of the rank of the dealer's blackjack hand to the rank of the player's blackjack hand;
said processing unit arranging the player's five cards into a player's five card stud hand and the dealer's five cards into a dealer's five card stud hand;
said processing unit comparing the rank of the dealer's five card stud hand to the rank of the player's five card stud hand; and
said processing unit settling the player's second wager dependent upon the comparison of the rank of the dealer's five card stud hand to the rank of the player's five card stud hand.

11. The method of claim 10 wherein a player automatically wins the blackjack hand if all five of the player's cards are exposed, and the value of the five cards added together is less than seventeen.

12. The method of claim 10, wherein said five card stud hand is a five-card lo stud hand.

13. The method of claim 10, further comprising accepting a bonus wager from a player, and having a payout associated with pre-established ranking of each player's five-card stud hand.

14. A method of playing a wagering game utilizing one or more decks of standard playing cards comprising:
accepting a first wager, a second wager and an optional bonus wager from each participating player;
dealing each player five cards, wherein two cards are dealt face-up and 3 cards are dealt face-down, and wherein the two face-up cards constitute a player's blackjack hand;
dealing a dealer five cards, wherein one card is dealt face-up and 4 cards are dealt face-down, and wherein the one face-up card constitutes a dealer's blackjack hand;
requiring each player and the dealer to make a blackjack hand by using their respective five cards;
collecting the first wager if the player's blackjack hand exceeds twenty-one in total;
if the player's blackjack hand does not exceed twenty-one, comparing the rank of the dealer's blackjack hand to the rank of each player's blackjack hand;
settling each player's first wager dependent upon the comparison of the rank of the dealer's blackjack hand to the rank of each player's blackjack hand;
exposing each player's five cards and the dealer's five cards;
comparing the rank of the dealer's five-card stud hand to the rank of each player's five-card stud hand;
settling each player's second wager dependent upon the comparison of the rank of the dealer's five-card stud hand to the rank of each player's five-card stud hand;
establishing a pay table that defines the bonus wager winning combinations and corresponding payouts; and
settling each player's bonus wager dependent upon the comparison of the rank of the player's five-card stud hand with the winning combinations in the pay table.

15. The method of playing a wagering game of claim 14, wherein a player automatically wins the blackjack hand if all five of the player's cards are exposed, and the value of the five cards in total is less than seventeen.

16. The method of playing a wagering game of claim 14, wherein said five card stud hand is a five-card lo stud hand.

17. The method of playing a wagering game of claim 14, wherein the one or more decks include a joker which can be used as a wild card or to complete certain pre-established hands.

18. The method of playing a wagering game of claim 14, wherein the player's three face-down cards are stacked, and the player's blackjack hand is constructed by flipping over the next card in the stack to be utilized in the player's blackjack hand when the player requests a hit.

19. The method of playing a wagering game of claim 14, wherein the player's three face-down cards are separate and not stacked, and the blackjack hand is constructed by the player pointing to one of the player's three face-down cards to be exposed and to be utilized in the player's blackjack hand when the player requests a hit.

20. The method of playing a wagering game of claim 14, further comprising utilizing one of the three face-down cards in the player's blackjack hand if the player requests a hit, and utilizing one of the four face-down cards in the dealer's blackjack hand if the dealer is required to take a hit, wherein the dealer is required to take a hit when the dealer's blackjack hand is less than seventeen in total.
